(19) United States
(12) Patent Application Publication
(10) Pub. No.: US 2013/0077530 A1
(43) Pub. Date: Mar. 28, 2013

(54) Scaling IPv6 on Multiple Devices Virtual Switching System with Port or Device Level Aggregation

(71) Applicants: Ming Zhang, San Jose, CA (US); Chengelpet Ramesh, San Jose, CA (US); Fangping Liu, San Jose, CA (US)

(72) Inventors: Ming Zhang, San Jose, CA (US); Chengelpet Ramesh, San Jose, CA (US); Fangping Liu, San Jose, CA (US)

(73) Assignee: Cisco Technology, Inc., San Jose, CA (US)

(21) Appl. No.: 13/247,497

(22) Filed: Sep. 28, 2011

(51) Int. Cl. H04J 3/24; H04L 12/28

(52) U.S. Cl. 370/255; 370/474

(57) ABSTRACT

Systems and methods are provided to support a large number of hosts while keeping the size of the FIB CAM low. Higher scalability may be achieved by consuming less FIB CAM space as hosts are added to a network. An L3 switching module may be provided capable of supporting a large number of virtual machines and/or hosts while maintaining a small FIB CAM size on a multiple device virtual switching system with port or device level aggregation.

### BACKGROUND

Traditional multiple switch device systems require an increase in the size of the forwarding information base (“FIB”) content-addressable memory (“CAM”) as the number of hosts increase. However, such an increase creates high monetary and power costs. There exists a desire to support large numbers of hosts without increasing the FIB CAM size. The issue is particularly challenging in the IPv6 environment as IPv6 prefixes/addresses consume more CAM space as compared to IPv4. Subnet prefixes may be used as a form of aggregation for a double-lookup-forwarding architecture. However, such prefixes may not work on a configuration where the VLAN spans across different switching devices because at an ingress switching device there is no conclusion as to which egress switching device a packet should be forwarded to based on the subnet prefix associated with the VLAN.

As such, there exists a need for an IPv6 Layer-3 (“L3”) switching module capable of supporting a large number of virtual machines and/or hosts while maintaining a small FIB CAM size on a multiple device virtual switching system with port or device level aggregation.

### BRIEF DESCRIPTION OF THE DRAWINGS

The accompanying drawings, which are incorporated in and constitute a part of this disclosure, illustrate various embodiments. In the drawings:

FIG. 1 illustrates an example network environment for embodiments of this disclosure;

FIG. 2 illustrates the IPv6 address format;

FIG. 3 illustrates an IPv6 address format according to embodiments of this disclosure;

FIG. 4 illustrates example embodiments of the present disclosure;

FIG. 5 illustrates an IPv6 address format according to embodiments of this disclosure;

FIG. 6 is a flow chart illustrating embodiments of this disclosure;

FIG. 7 is a flow chart illustrating embodiments of this disclosure; and

FIG. 8 is a block diagram of a computing network device.

### DESCRIPTION OF EXAMPLE EMBODIMENTS

### Overview

Consistent with embodiments of the present disclosure, systems and methods are disclosed for resolving a critical scalability issue for multiple switch device systems with VLANs spanning across multiple devices.

It is to be understood that both the foregoing general description and the following detailed description are examples and explanatory only, and should not be considered to restrict the application's scope, as described and claimed. Further, features and/or variations may be provided in addition to those set forth herein. For example, embodiments of the present disclosure may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments of this disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

As the virtual machine (“VM”) concept is introduced into campus and data center networks, the number of hosts connected by switching systems at the data center grows dramatically, even in the order of millions. Traditional three-tier network architectures can no longer meet the requirements of these types of networks as more and more switches and routers must be added as the number of VMs grow. Latency, complexity, and cost may increase as well.

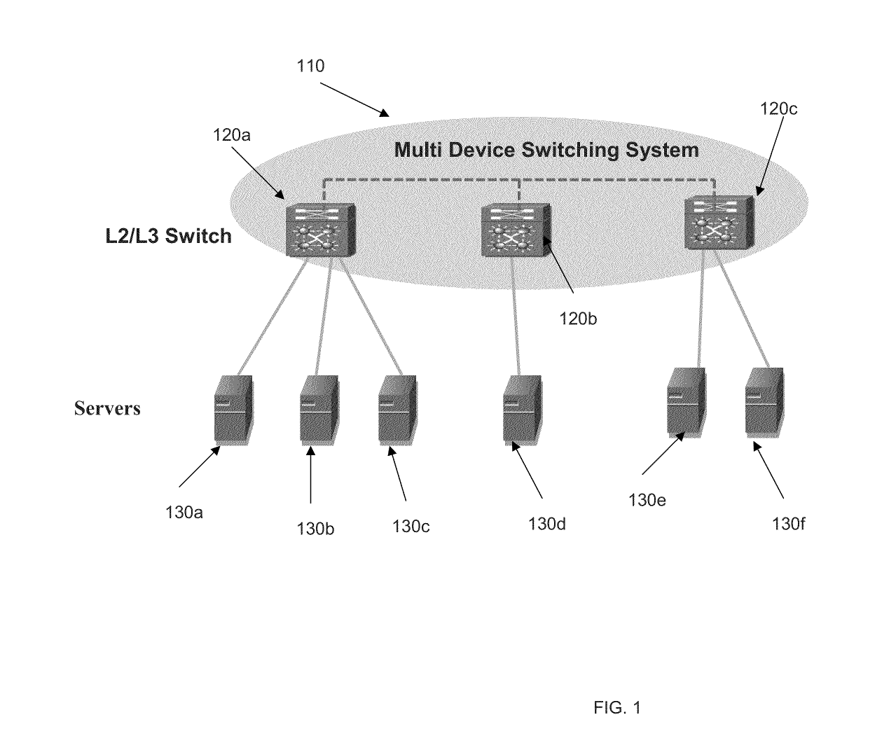

FIG. 1 illustrates an example network environment for embodiments of this disclosure. Example networks may be designed with a flattened architecture that consists of a multi device switching system 110. Multi device switching system 110 may comprise a plurality of L2/L3 switching devices 120a-c. Switching devices 120 a-c may each be connected to a number of servers 130a-f.

In some embodiments, switching devices 120a-c may be directly linked together or (full-mess or cascade architecture) or through a switching fabric device (hub-spoke architecture) to form a virtual switch. All these switching devices may be controlled by a central controller. Routing protocols may run on the central controller as a single routing entity. All traffic may travel through the system as if switching through a single switching device. In such a switching system, a packet forwarded across switching devices 120 a-c may go through two stages of hardware lookup and forwarding, once at an ingress switching device and once at an egress switching device.

IPv6 Protocol is designed to support a much greater number of addressable nodes and more capability of addressing hierarchy with a larger address size (128 bits). With the larger IPv6 address space, there is more flexibility for assigning network prefixes and addresses. This creates the possibility for aggregation.

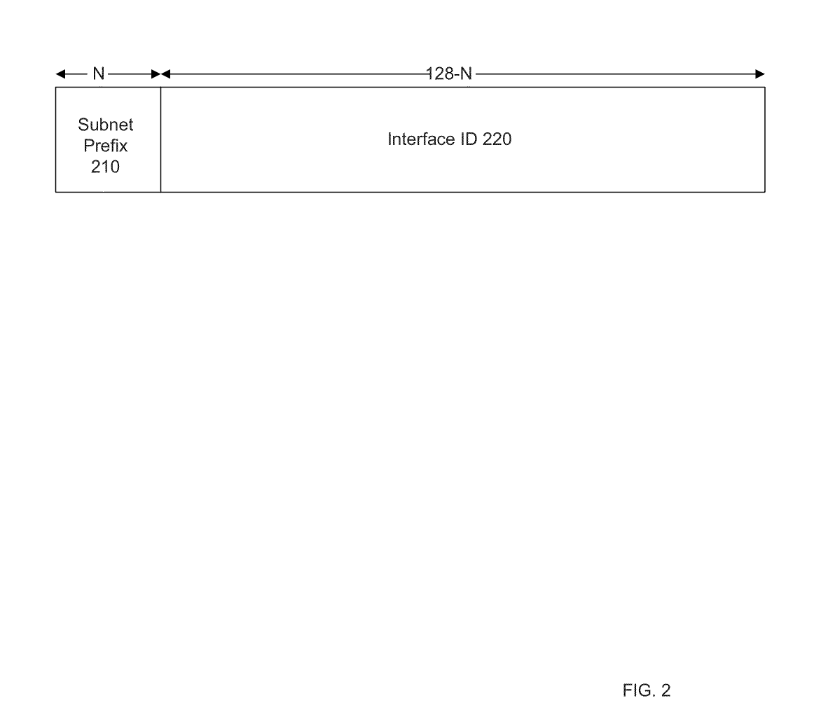

FIG. 2 illustrates the IPv6 address format. The higher N bits may be used to store the subnet prefix 210. Subnet prefix 210 may be the subnet prefix assigned to the L3 interface. The remaining 128-N bits may be used to store the interface ID 220. Interface ID 220 may be used to identify the host connected to the L3 interface.

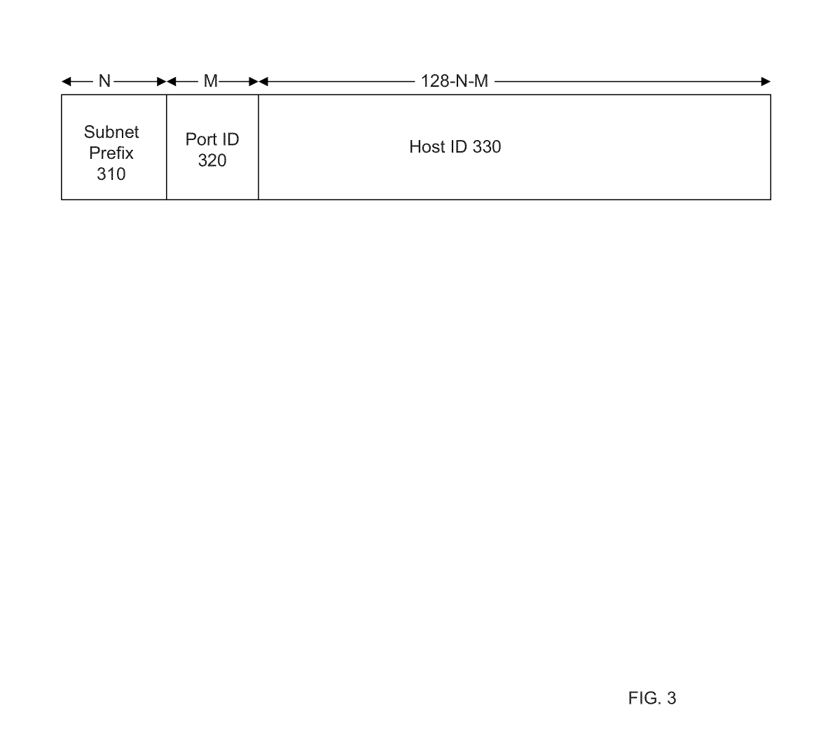

FIG. 3 illustrates an IPv6 address format according to embodiments of this disclosure. The highest N bits may be used to store the subnet prefix 310. The next M bits may be allocated for a port ID 320. The port ID 320 may uniquely identify a particular port associated with a switching device on the network. The remaining 128-N-M bits may be used to store the host ID 330. A port prefix may be formed by combining the subnet prefix and the port ID.

Embodiments described herein may be based on the configuration that a L3 virtual interface consists of multiple L2 switch ports. Furthermore, each of the multiple L2 switch ports may share the same VLAN ID. An L2 switch port associated with a switching device may be connected to multiple hosts or VMs. The port prefix may be provisioned on a port of a switching device. The port prefix length (N+M) may be the same or different on different ports depending upon the number of hosts connected to the port.

All port prefixes associated with a VLAN interface should be summarized by the subnet prefix on the VLAN interface. All assigned host addresses associated with the port should be summarized by the port prefix configured on the switching device. In some embodiments, subnet prefixes, port prefixes, and host addresses may be assigned through a DHCP server and other network management tools.

In operating environment according to embodiments described herein, a plurality of L2 ports associated with switching devices may reside on the same VLAN. An L3 virtual interface may be configured as described above. The L2 ports may be spread across multiple switching devices. In this setting, prior systems could not employ subnet prefix aggregation as the multiple destination switching devices may be associated with the same subnet prefix.

Embodiments described herein may install a port prefix in FIB CAM tables on all switching devices except for the local switching device. A destination port index may be installed as the destination index for the port prefix. These port prefix FIB entries may be used for ingress lookup. On the egress switching device, only local neighbor entries may be installed in the FIB CAM table on the local switching device. Neighbor FIB entries may be employed for egress lookup. If both the source and destination are on the same switching device, neighbor FIB entries may be used for FIB lookup as only one FIB lookup is required. Subnet prefixes may be installed on a local switching device, where the local switching device is configured to punt the entry neighbor discovery packet to the central controller CPU for processing.

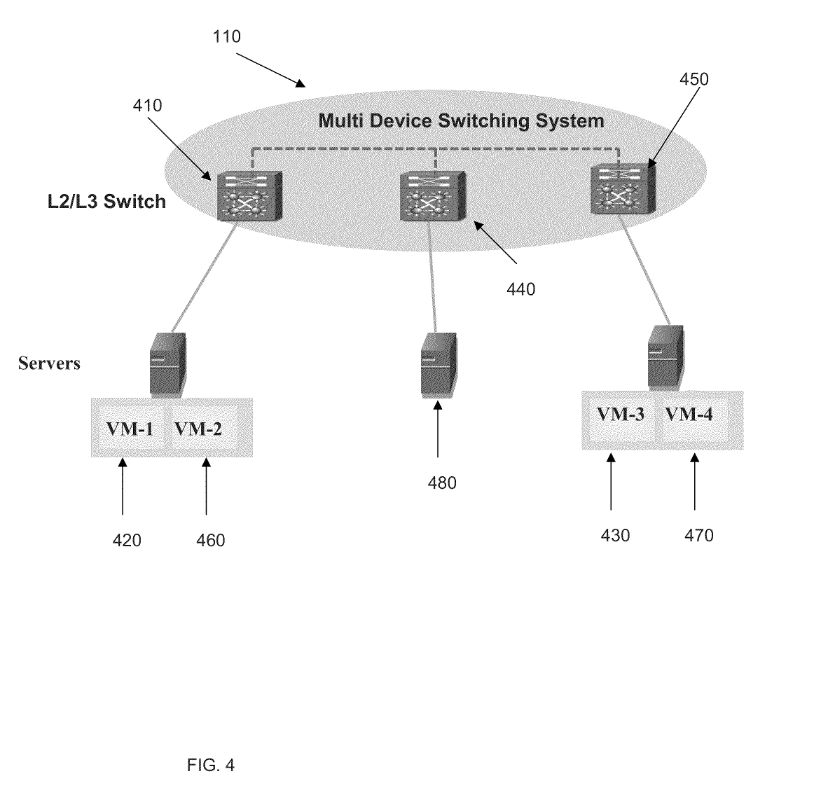

FIG. 4 illustrates example embodiments of the present disclosure. Port prefix PP1 may be configured on a port associated with a switching device 450 connecting to VM 430 and VM 470. Port prefix PP1 may be installed in FIB CAM on switching device 410 and switching device 440. If an IPv6 packet comes from VM 420 with a destination of VM 430, it may arrive at switching device 410. The L3 ingress lookup may hit port prefix PP1 with a destination index pointing to switching device 450.

Without L2 rewrite, the frame is forwarded to egress at switching device 450. At this stage, the MAC of the destination has been discovered by the system. A L3 egress lookup may then hit the destination CAM entry for VM 430. The packet will subsequently be forwarded to VM 430. Reverse traffic may be forwarded the same way with a port prefix provisioned on switch device 410 and installed in FIB CAM on switching device 450.

On a pure L3 interface without VLAN association, the subnet prefix configured on the interface with destination port index may be installed on all other associated switch devices. A packet arriving at an ingress switch device may hit the subnet prefix. The packet may then be forwarded to the egress switch device and reach its final destination.

On an Ether-channel (LAG) interface, the subnet prefix configured on the interface with Ether-channel destination index may be installed on all other associated switch devices. A packet arriving at an ingress switch device may hit the subnet prefix. The packet may then be forwarded to a switch device depending upon an Ether-channel load balancing algorithm. The packet may then be forwarded by the egress switch device based on egress lookup.

The maximum number of hosts that may be supported by embodiments of this disclosure may be calculated via formula [1]

H=(F−P×V×S)×S [1]

H represents the maximum number of hosts supported. F represents the size of the FIB. P represents the number of ports associated per switching device. V represents the number of VLANs per port. S represents the number of switch devices being employed. For example, with a FIB CAM size of 16,000 IPv6 entries, 100 switch devices, 48 ports per switch device, 1 VLAN per port, 1.1 million hosts may be supported.

In some embodiments, for increased scalability, the port prefix may be installed on ingress switch devices based on active traffic flows. For example, the port prefix would only be installed on those switch devices that have active traffic flow. The traffic flow may be monitored and the port prefix should be removed from the ingress switch device if traffic flow stops for a predetermined period of time. With this approach the FIB CAM size may be even smaller if hosts connected to a port device do not communicate with hosts connected to all other ports on other switch devices.

The maximum number of hosts that may be supported by embodiments of the previous paragraph may be calculated via formula [2]

H=(F−P×V×S×C %)×S [2]

C % represents the percentage of active traffic flows between ports associated with active switching devices. For example, with a FIB CAM size of 16,000 IPv6 entries, 100 switch devices, 48 ports per switching device, 2 VLANs per port, with 50% active flow, 1.1 million hosts may be supported.

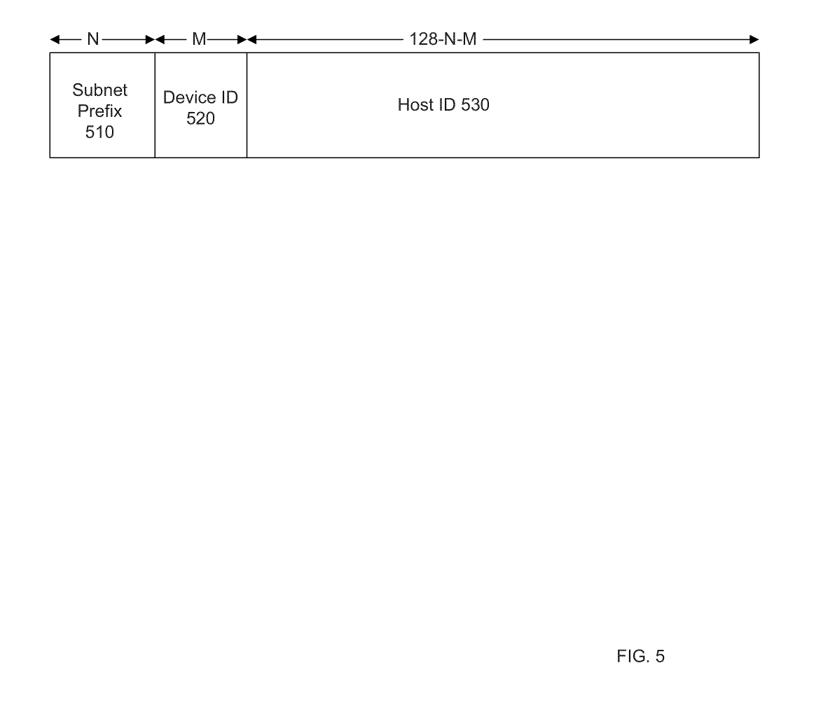

Embodiments of this disclosure consider the scenarios where port level aggregation may not meet the requirements of a campus or data center environment where many VLANs may be provisioned. As the port prefix should be provisioned on a per-port/per-VLAN basis, the number of port prefixes may grow as the number of VLANs per port grows. In these environments, embodiments may allocate M bits for the device ID from the interface ID space as illustrated in FIG. 5.

FIG. 5 illustrates an IPv6 address format according to embodiments of this disclosure. The highest N bits may be used to store the subnet prefix 510. The next M bits may be allocated for a device ID 520. The device ID 520 may identify an individual device on the system. The remaining 128-N-M bits may be used to store the host ID 530. A device prefix may be formed by combining the subnet prefix and the device ID.

The device prefix may be provisioned on a switch device, one for each VLAN on the switch device. The device prefix is used to summarize all hosts connected to the switch device on the same VLAN. The device prefix may be installed on the FIB CAMs associated with the other switch devices for ingress lookup.

The approaches for use of the port prefix may be employed with the device prefix. However, the ingress lookup is based on the device prefix as opposed to the port prefix. The use of the device prefix also allows for a much higher degree of scalability for systems provisioned with many VLANs.

The maximum number of hosts that may be supported by embodiments of this disclosure employing the device prefix may be calculated via formula [3]

H=(F−V×S)×S [3]

H represents the maximum number of hosts supported. F represents the size of the FIB. V represents the number of VLANs per device. S represents the number of switch devices being employed. For example, with a FIB CAM size of 16,000 IPv6 entries, 100 switch devices, 1 VLAN per device, 1.6 million hosts may be supported. Similarly, with a FIB CAM size of 16,000, 100 switch devices, 50 VLANs per device, 1.1 million hosts may be supported.

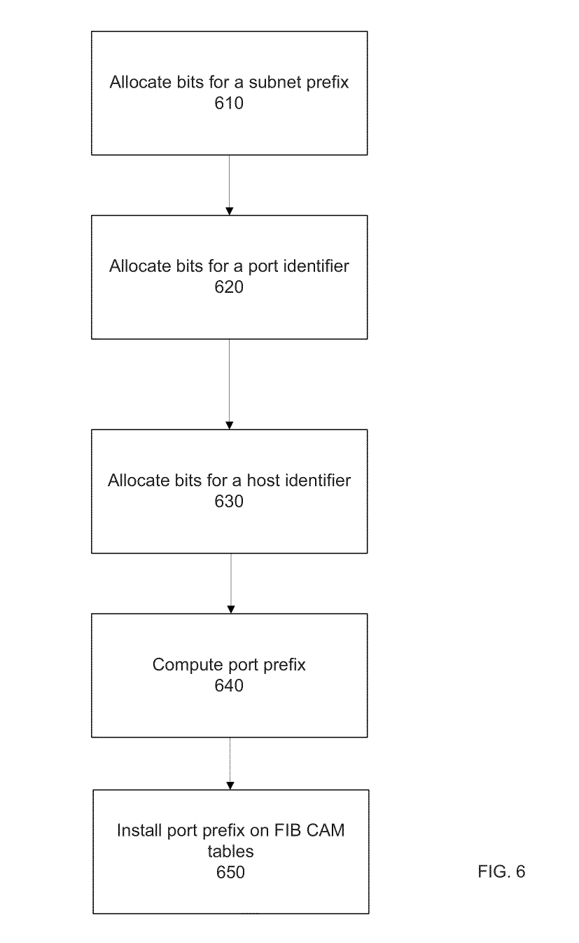

FIG. 6 is a flow chart illustrating embodiments of this disclosure. Method 600 may begin at step 610 where a first quantity of bits in an IPv6 address may be allocated for storing a subnet prefix. Method 600 may then proceed to step 620, where a second quantity of bits in the IPv6 address may be allocated for storing a port identifier.

Method 600 may then proceed to step 630. At step 630, the remaining bits in the IPv6 address may be allocated for storing a host identifier. In some embodiments, the IPv6 address is appended to a packet transmitted across a Level-3 virtual interface comprised of a plurality of Layer-2 switch ports. Method 600 may then proceed to step 640 where a port prefix may be computed by combining the subnet prefix and the port identifier.

In some embodiments, two or more of the plurality of switching devices may share the same VLAN identification. Furthermore, at least one of the switching devices may be connected to one or more virtual machines. Method 600 may then proceed to step 650 where the port prefix may be installed in FIB CAM tables on a plurality of the switching devices. In some embodiments, all assigned host addresses associated with the port may be summarized by the port prefix.

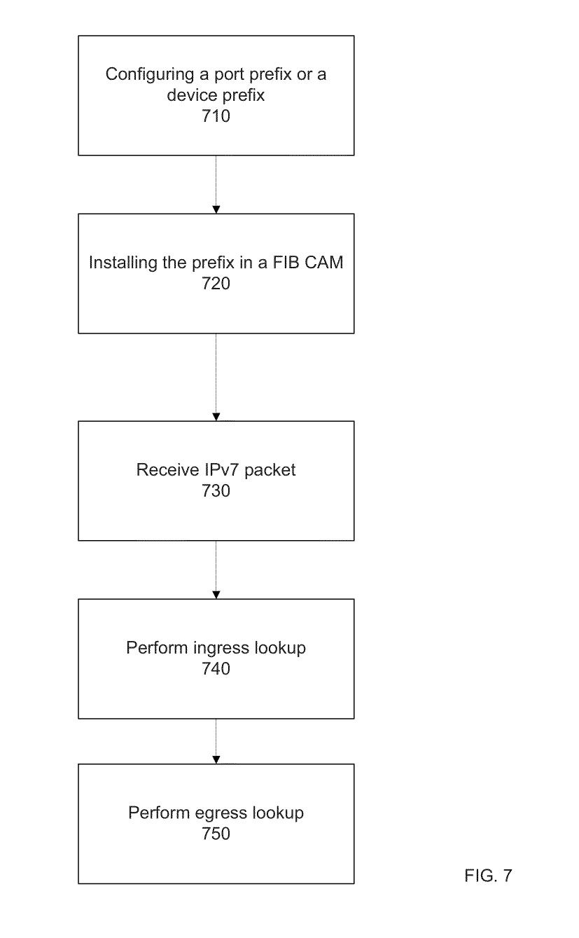

FIG. 7 is a flow chart illustrating embodiments of this disclosure. Method 700 may begin at step 710, where one of: a port prefix and/or a device prefix is configured. The prefix is determined based on IPv6 address information as described above in regards to FIG. 3 and FIG. 5. In some embodiments, the configuration may take place on a switching device. The switching device may reside on a path between the first virtual machine and the second virtual machine.

Method 700 may then proceed to step 720. At step 720, the prefix may be installed in a FIB CAM at the ingress switching device. In some embodiments, the prefix may comprise a destination index pointing to an egress switch device. Method 700 may then proceed to step 730, where an IPv6 packet may be received from a first virtual machine addressed to a second virtual machine.

Subsequent to the receipt of the IPv6 packet, method 700 may proceed to step 740. At step 740, an ingress lookup may be performed. The ingress lookup may locate the designated prefix. In some embodiments, method 700 may proceed to step 750, where an egress lookup may be performed as the packet traverses to its destination. The egress lookup may locate a destination entry on the FIB CAM corresponding to the second virtual machine. In some embodiments, the packet may be forwarded to the egress switch device based on the results of a load balancing algorithm. In some embodiments, method 700 may be performed on an L3 interface without VLAN association.

An embodiment consistent with this disclosure may comprise an apparatus for scaling IPv6 on multiple devices. The system may comprise a processor coupled to a memory, wherein the processor is operative to determine a port prefix value based on IPv6 address information. The processor may be further configured to install the port prefix value in FIB CAM tables associated with a plurality of connected switching devices.

The processor may further be configured to use the port prefix value for ingress lookup. In some embodiments, the apparatus may be a switching device. The switching device may reside on the same VLAN as the plurality of connected switching devices. The processor may be further configured to punt an entry data packet to a central controller for processing.

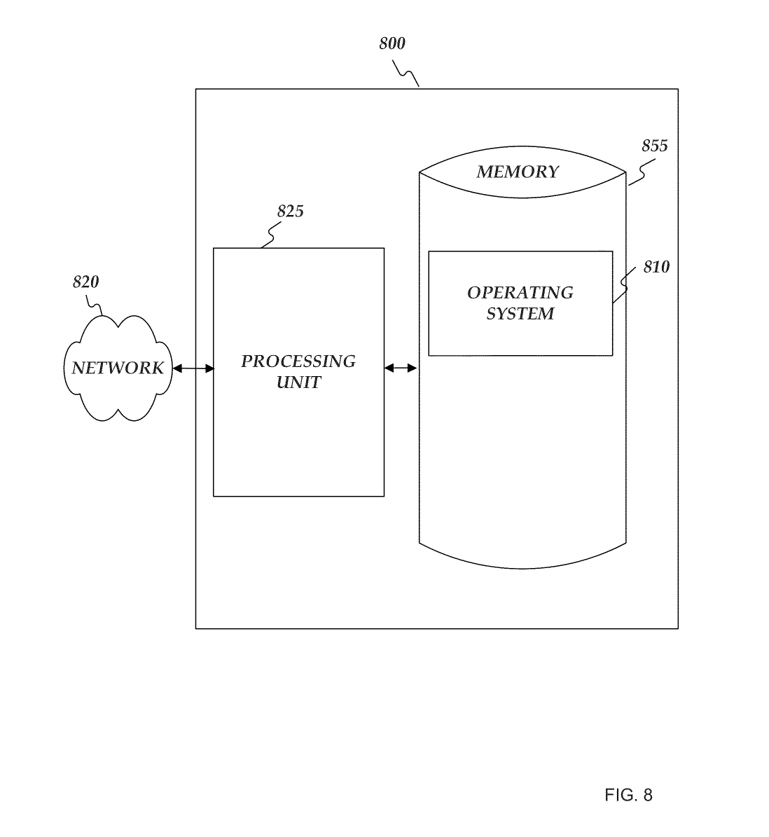

FIG. 8 illustrates a computing device 800. Computing device 800 may include processing unit 825 and memory 855. Memory 855 may include software configured to execute application modules such as an operating system 810. Computing device 800 may execute, for example, one or more stages included in the methods as described above. Moreover, any one or more of the stages included in the above describe methods may be performed on any element shown in FIG. 8.

Computing device 800 may be implemented using a personal computer, a network computer, a mainframe, a computing appliance, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

Embodiments of the present disclosure, for example, are described above with reference to block diagrams and/or operational illustrations of methods, systems, and computer program products according to embodiments of this disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and are the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

What is claimed is:

1. A method comprising:
configuring one of: a port prefix and a device prefix;
installing one of: the port prefix and the device prefix in a FIB CAM;
receiving an IPv6 packet from a first virtual machine addressed to a second virtual machine; and
performing an ingress lookup, which locates the one of: the port prefix and the device prefix.

2. The method of claim 1, wherein configuration of one of: a port prefix and a device prefix occurs on a switching device.

3. The method of claim 2, wherein the switching device resides on a path between the first virtual machine and the second virtual machine.

4. The method of claim 1, wherein the port prefix comprises a destination index pointing to an egress switching device.

5. The method of claim 4, further comprising performing an egress lookup, which locates a destination entry on the FIB CAM corresponding to the second virtual machine.

6. The method of claim 1, wherein the method is performed on an L3 interface without VLAN association.

7. The method of claim 5, further comprising forwarding the packet to the egress switching device.

8. An apparatus comprising:
a memory; and
a processor coupled to the memory, wherein the processor is operative to:
determine one of: a port prefix value and a device prefix value based on IPv6 address information; and
install one of: the port prefix value and the device prefix value in FIB CAM tables associated with a plurality of connected switching devices.

9. The apparatus of claim 8, wherein the processor is further configured to:
use one of: the port prefix value and the device prefix value for ingress lookup.

10. The apparatus of claim 9, wherein the apparatus is a switching device with a plurality of ports.

11. The apparatus of claim 10, wherein the processor is further configured to:
allocate a first quantity of bits in an IPv6 address for storing a subnet prefix;
allocating a second quantity of bits in the IPv6 address for storing a device identifier; and
allocating the remaining bits in the IPv6 address for storing a host identifier.

12. The apparatus of claim 10, wherein the plurality of connected switching devices reside on the same VLAN.

13. The apparatus of claim 11, wherein the processor is further configured to compute a device prefix by combining the subnet prefix and the device identifier.

14. A method comprising:
allocating a first quantity of bits in an IPv6 address for storing a subnet prefix;
allocating a second quantity of bits in the IPv6 address for storing a port identifier; and
allocating the remaining bits in the IPv6 address for storing a host identifier.

15. The method of claim 14, wherein the IPv6 address is appended to a packet transmitted across a Level-3 virtual interface comprised of a plurality of Layer-2 switching devices.

16. The method of claim 14, further comprising computing a port prefix by combining the subnet prefix and the port identifier.

17. The method of claim 16, wherein two or more of the plurality of switching devices share the same VLAN identification.

18. The method of claim 17, wherein at least one of the switching devices is connected to one or more virtual machines.

19. The method of claim 15, further comprising installing the port prefix in FIB CAM tables on a plurality of the switching devices.

20. The method of claim 19, further comprising summarizing all assigned host addresses by the port prefix.
